(19) United States
(12) Patent Application Publication
(10) Pub. No.: US 2025/0313105 A1
(43) Pub. Date: Oct. 9, 2025

(54) DUAL MOTOR INVERTER SYSTEMS WITH INTEGRATED AC-TO-DC ONBOARD CHARGERS

(71) Applicant: Ford Global Technologies, LLC, Dearborn, MI (US)

(72) Inventor: Mohamed Elshaer, Canton, MI (US)

(21) Appl. No.: 18/626,732

(22) Filed: Apr. 4, 2024

(51) Int. Cl. B60L 53/22; B60W 20/13; H02M 1/42; H02M 3/335; H02M 7/5387

(52) U.S. Cl. CPC B60L 53/22; B60W 20/13; H02M 1/4233; H02M 3/33584; H02M 7/53871; B60L 2210/10; B60L 2210/42

(57) ABSTRACT

Systems are provided for integrating AC-to-DC onboard chargers into dual motor inverter systems. In one example, a system may include a first motor inverter system having a first electric a first motor inverter system having a first electric motor circuitry and a first inverter system controller (ISC) circuitry and a second motor inverter system having a second electric motor circuitry and a second ISC circuitry. The system may also include a first onboard charger circuitry electrically connected to the first electric motor circuitry and electrically connected to the first ISC circuitry, and a second onboard charger circuitry electrically connected to the first ISC circuitry. The first onboard charger circuitry, the first ISC circuitry, and the second onboard charger circuitry may form a bi-directional power factor correction circuit.

### FIELD

The present description relates generally to dual motor inverter systems and corresponding alternating current (AC) to direct current (DC) onboard chargers.

### BACKGROUND/SUMMARY

Dual motor inverter systems are increasingly popular among manufacturers of high-performance electric vehicles due to features thereof, such as enhanced torque, high power density, and low production resources. Such systems may provide a range of benefits, including an ability to have a front motor and a rear motor power the wheels, which may facilitate and/or enable advanced torque management and superior handling.

A dual motor inverter system may serve as a central component for enhanced power management and/or optimization of driving experiences, by enhancing torque and/or vehicle handling. An isolated AC-to-DC onboard charger may be used to efficiently transform power from an AC power grid into a form suitable for charging an electric vehicle's battery (e.g., a DC power), which may directly affect charging time and/or general usability of the vehicle. A high voltage (HV) traction battery disconnect circuit may operate to ensure and/or facilitate a traction battery's isolation during maintenance (as well as during immediate interruptions of high-voltage flows) to mitigate operational issues and enhance the vehicle's operational reliability. These components may accordingly work in harmony to optimize performance and operation of electric vehicles.

However, the inventors herein have recognized potential issues with such systems. Some designs may affect efficiency and/or performance, and may impose additional packaging and/or thermal management constraints.

These issues identified may be mitigated and/or addressed by new circuit architectures for dual motor inverter systems with integrated AC-to-DC onboard chargers. Such new circuit architectures may have streamlined designs and/or increased power density, and may lead to reductions in system volumes. The resulting unified circuits may be capable of multiple functions, which may in turn advantageously simplify the system and/or may reduce component count. Moreover, system integration may advantageously facilitate and/or enable movement toward unified fluid cooling systems, which may lead to reduced system sizes and/or weights, thus enhancing performance and/or enhancing driver experience.

In some embodiments, the issues described above may be addressed by a dual motor inverter system comprising a first motor inverter system, a second motor inverter system, a first integrated onboard charger circuitry, and a second integrated onboard charger circuitry. The first motor inverter system may have a first electric motor circuitry and a first inverter system controller (ISC) circuitry, and the second motor inverter system may have a second electric motor circuitry and a second ISC circuitry. The first onboard charger circuitry may be electrically connected to the first electric motor circuitry and electrically connected to the first ISC circuitry, and the second onboard charger circuitry may be electrically connected to the first ISC circuitry. The first onboard charger circuitry, the first ISC circuitry, and the second onboard charger circuitry may form a bi-directional power factor correction (PFC) circuit. In this way, the bi-directional PFC circuit may advantageously permit disconnection of two electric motor windings from an inverter circuit while keeping a third electric motor winding connected to the inverter circuit, and/or may advantageously contribute to activation of a battery current control function.

For some embodiments, the issues described above may be addressed by a dual motor inverter system comprising a first motor inverter system, a second motor inverter system, and an onboard charger circuitry. The first motor inverter system may have a first electric motor circuitry and a first ISC circuitry, and the second motor inverter system may have a second electric motor circuitry and a second ISC circuitry. The onboard charger circuitry may be electrically connected to the second ISC circuitry, and the second motor inverter system and the onboard charger circuitry may form a bi-directional isolated DC-DC converter circuit. In this way, the onboard charger circuitry may be directly interfaced with the second ISC circuitry without disconnecting an attached electric motor.

In various embodiments, the issues described above may be addressed by a dual motor inverter system with a first motor inverter system, a second motor inverter system, a first onboard charger circuitry, as second onboard charger circuitry, and a third onboard charger circuitry. The first motor inverter system may have a first electric motor circuitry and a first ISC circuitry, and the second motor inverter system may have a second electric motor circuitry and a second ISC circuitry. The first onboard charger circuitry may be electrically connected to the first electric motor circuitry and may be electrically connected to the first ISC circuitry, the second onboard charger circuitry may be electrically connected to the first ISC circuitry, and the third onboard charger circuitry may be electrically connected to the second electric motor circuitry. These structures may advantageously facilitate a battery current control function while reducing circuits, circuitries, and components.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The disclosure may be better understood from reading the following description of non-limiting embodiments, with reference to the drawings below.

FIG. 1A shows a schematic view of a dual motor inverter system with an integrated AC-to-DC onboard charger, in accordance with one or more embodiments of the present disclosure;

FIGS. 1B-1D show a circuit topology for the dual motor inverter system with an integrated AC-to-DC onboard charger of FIG. 1A, and various circuitries thereof, in accordance with one or more embodiments of the present disclosure;

FIGS. 1E-1G show portions of the circuit topology for the dual motor inverter system with an integrated AC-to-DC onboard charger of FIG. 1B that form various circuits within the circuit topology, in accordance with one or more embodiments of the present disclosure;

FIG. 2A shows a schematic view of a second dual motor inverter system with an integrated AC-to-DC onboard charger, in accordance with one or more embodiments of the present disclosure; and

FIGS. 2B-2C show a circuit topology for the second dual motor inverter system with an integrated AC-to-DC onboard charger of FIG. 2A, and various circuitries thereof, in accordance with one or more embodiments of the present disclosure; and

FIG. 3 depicts a vehicle propulsion system, in accordance with one or more embodiments of the present disclosure.

### DETAILED DESCRIPTION

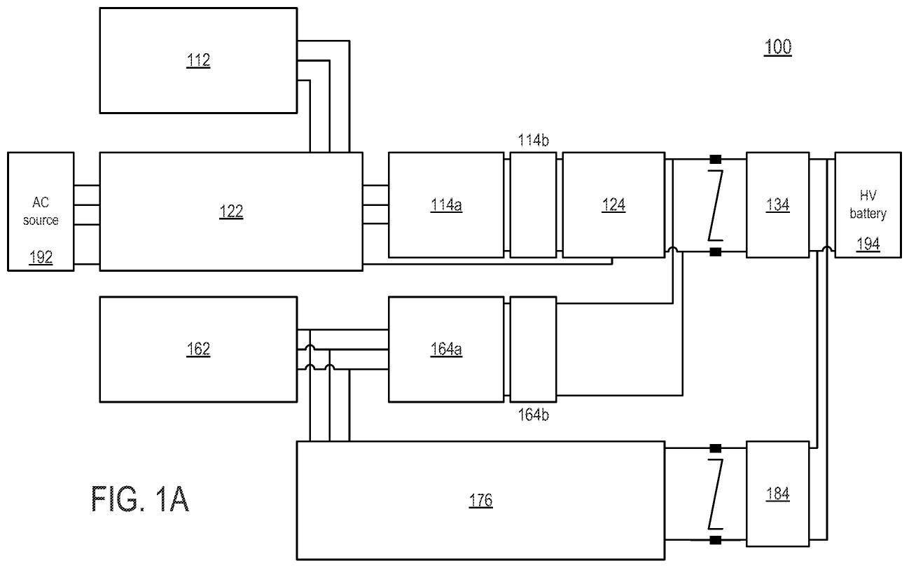

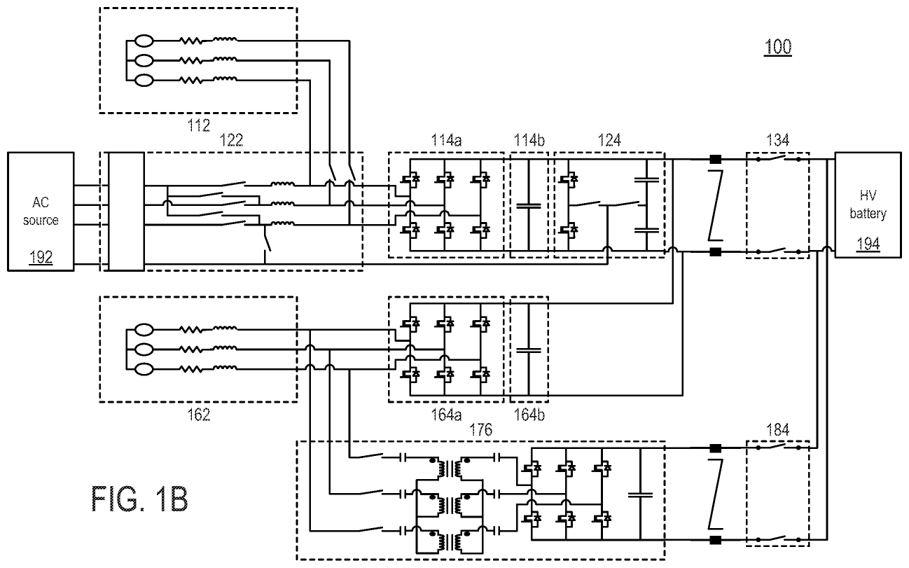

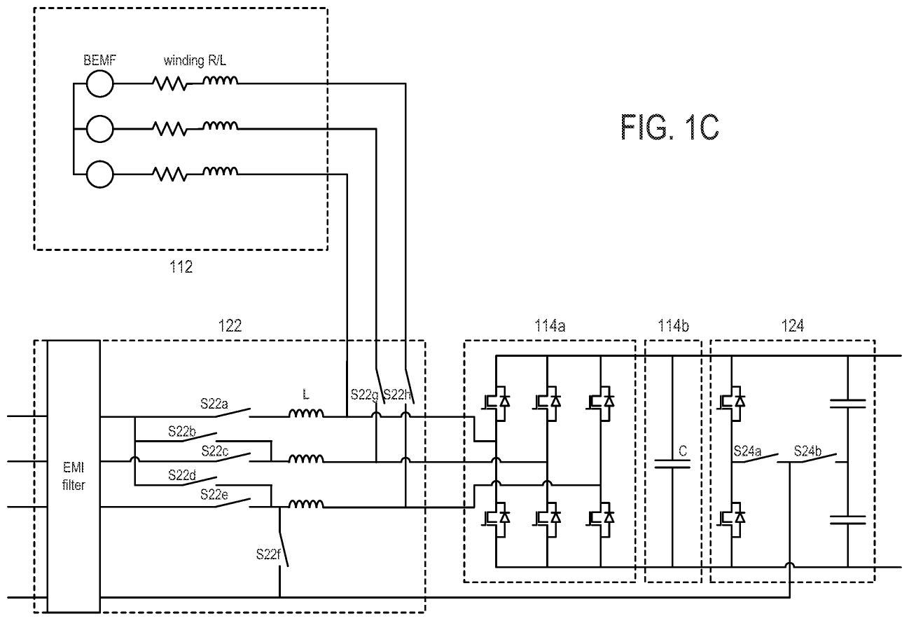

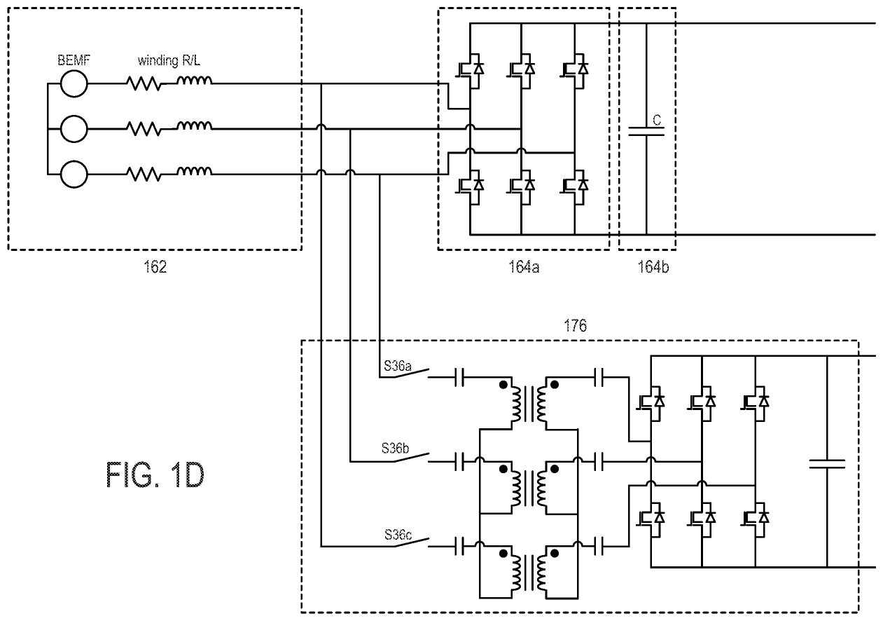

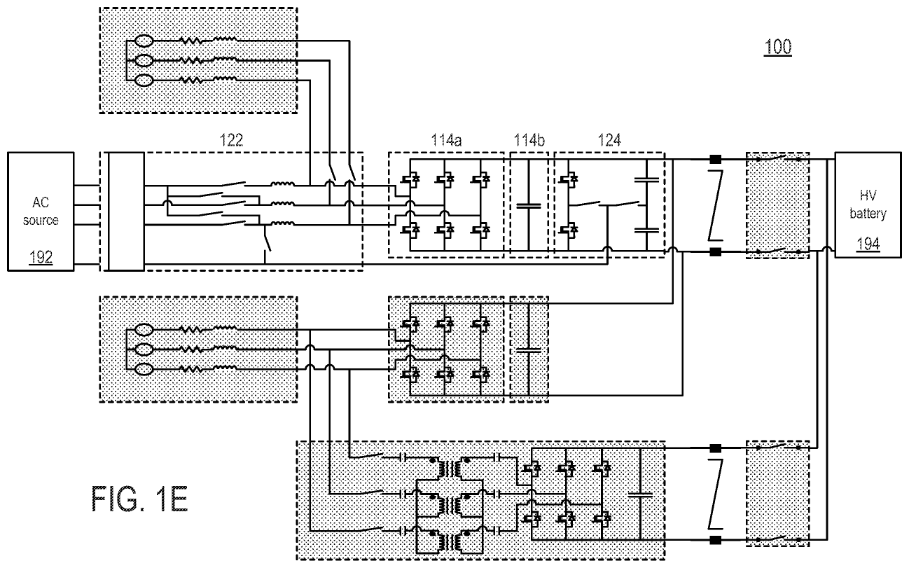

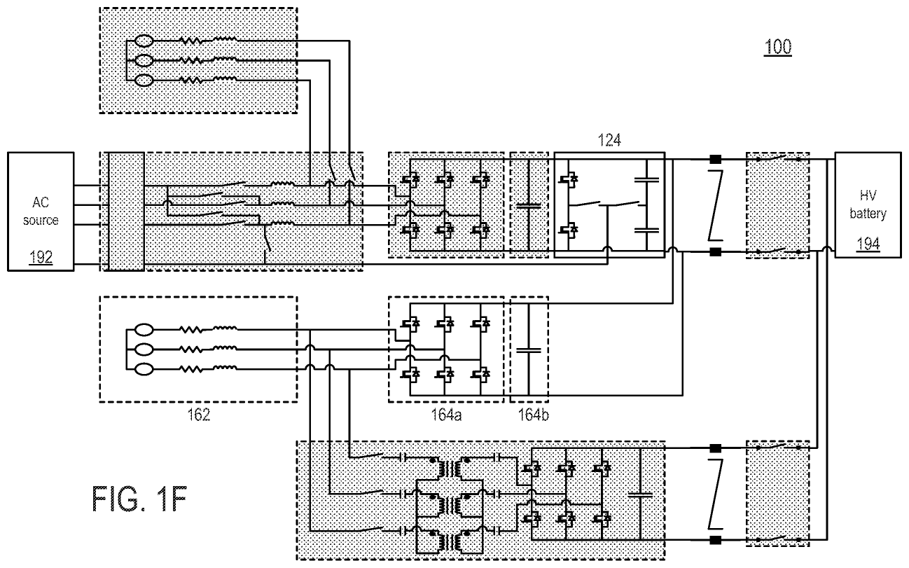

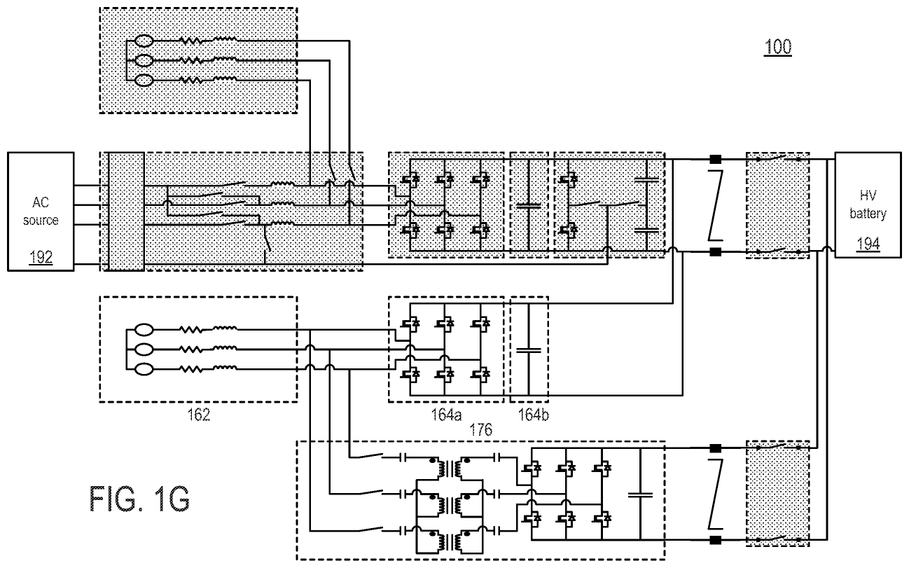

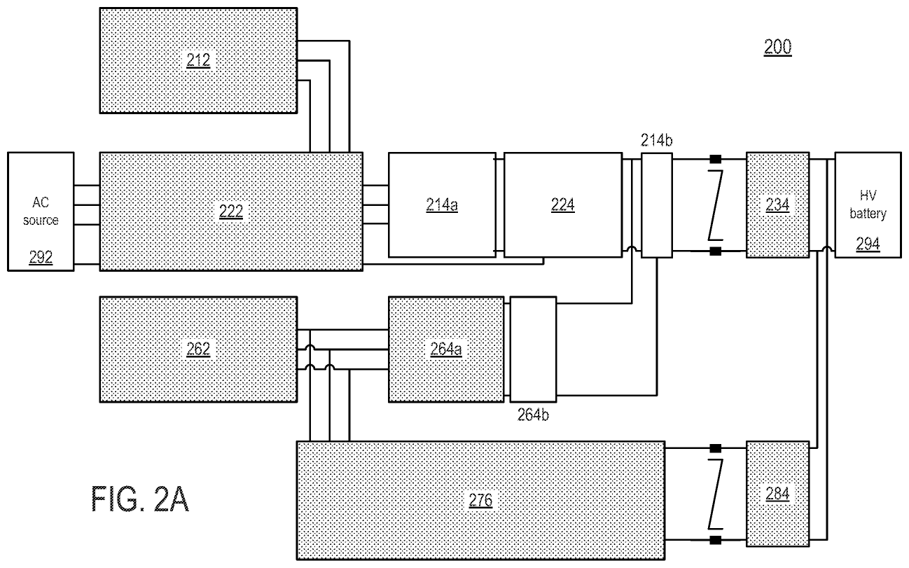

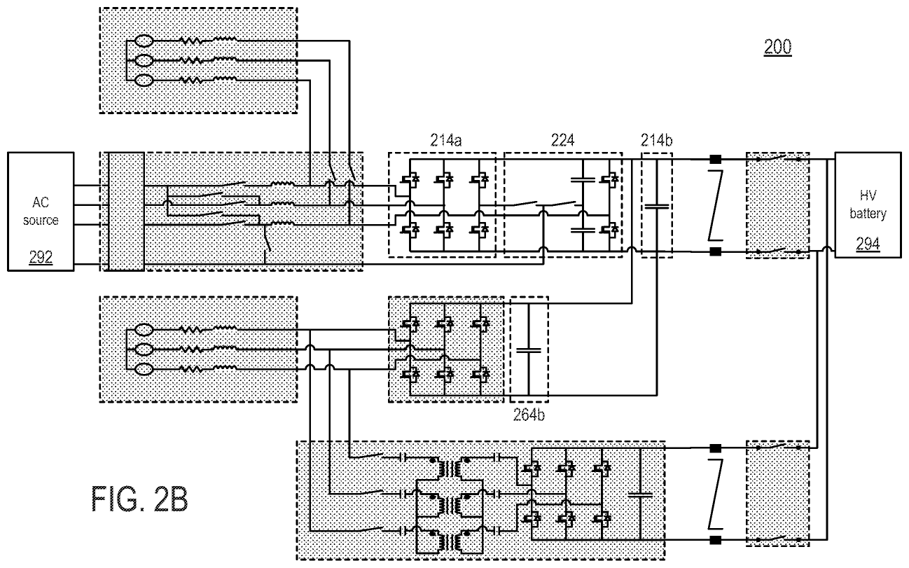

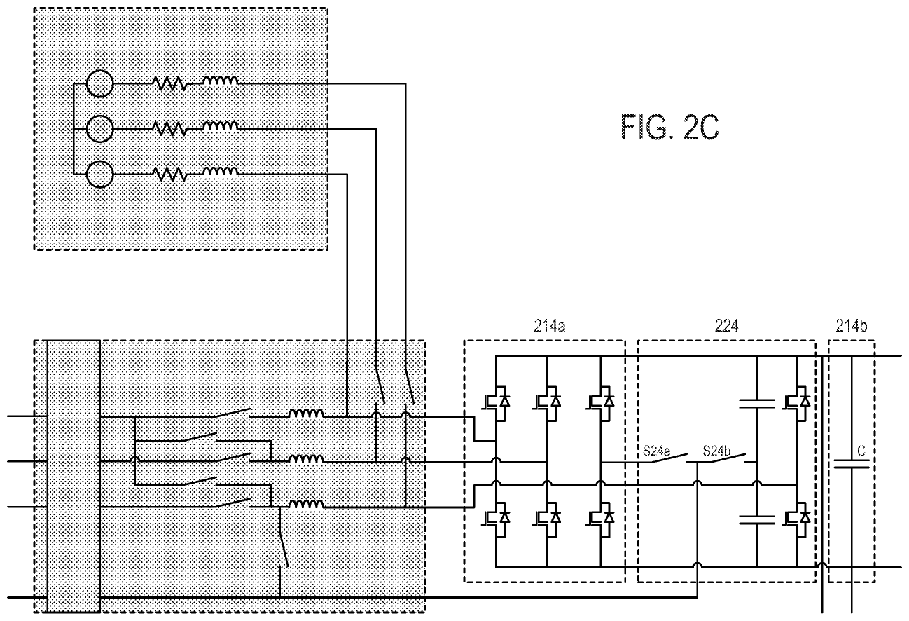

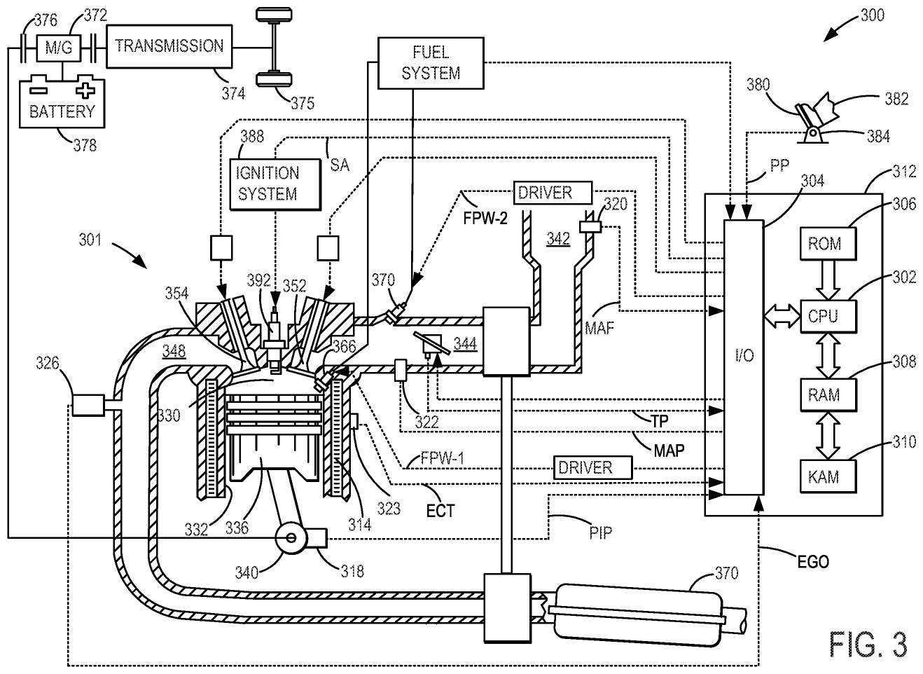

The following description relates to systems and circuit topologies for integrating an AC-to-DC onboard charger into a dual motor inverter system. FIGS. 1A-1D depict, in various views, a dual motor inverter system in which an AC-to-DC onboard charger has been integrated (and portions thereof). The implementation of the AC-to-DC onboard charger, and/or various elements thereof, has been spread out over three different circuitries connected to circuitries of the two motor inverter systems within the dual motor inverter system. FIGS. 1E-1G show portions of the dual motor inverter system with the integrated AC-to-DC onboard charger that form various circuits within the system, while FIGS. 2A-2C depict a second dual motor inverter system with an alternative design for some circuitries of the AC-to-DC onboard charger. FIG. 3 depicts an example vehicle propulsion system in which the disclosed dual motor inverter systems may be implemented.

FIGS. 1A-1D depict a system 100 (and portions thereof) in which an AC-to-DC onboard charger has been integrated with a dual motor inverter system. FIG. 1A shows a schematic view of system 100, illustrating various circuitries that form the dual motor inverter system of system 100, as well as the AC-to-DC onboard charger of system 100.

The dual motor inverter system of system 100 includes both a first motor inverter system and a second motor inverter system. The first motor inverter system includes a first electric motor circuitry 112 (e.g., an electric machine) and a first inverter system controller (ISC) circuitry corresponding with first electric motor circuitry 112. The first ISC circuitry has a first component 114a and a second component 114b. Accordingly, the first motor inverter system includes first electric motor circuitry 112, first component 114a of the first ISC circuitry, and second component 114b of the first ISC circuitry.

Similarly, the second motor inverter system includes a second electric motor circuitry 162 (e.g., an electric machine) and a second ISC circuitry corresponding with second electric motor circuitry 162. The second ISC circuitry has a first component 164a and a second component 164b. Accordingly, the second motor inverter system includes second electric motor circuitry 162, first component 164a of the second ISC circuitry, and second component 164b of the second ISC circuitry.

Since the dual motor inverter system of system 100 includes both the first motor inverter system and the second motor inverter system, the dual motor inverter system of system 100 thus includes first electric motor circuitry 112, first component 114a of the first ISC circuitry, and second component 114b of the first ISC circuitry, as well a second electric motor circuitry 162, first component 164a of the second ISC circuitry, and second component 164b of the second ISC circuitry.

The AC-to-DC onboard charger of system 100 is implemented across three different circuitries, each of which is integrated among the various circuitries of the first motor inverter system and the second motor inverter system, as discussed in further detail below. The AC-to-DC onboard charger includes a first onboard charger circuitry 122, a second onboard charger circuitry 124, and a third onboard charger circuitry 176.

An AC power source interface 192 provides input (e.g., electrical power via current and voltage) to system 100. A first battery disconnect circuit 134 and a second battery disconnect circuit 184 of system 100 are operable to open electrical connectivity between a traction battery interface 194 of system 100, which may be operable to interface with an HV battery (e.g., an HV traction battery), and various circuitries of system 100, and/or between traction battery interface 194 and various circuits of system 100 formed from the various circuitries thereof, in order to electrically isolate traction battery interface 194 various circuitries and circuits of system 100 (as discussed further herein).

FIG. 1C shows a portion of the circuit topology of system 100, including the first motor inverter system (e.g., first electric motor circuitry 112, first component 114a of the first ISC circuitry, and second component 114b of the first ISC circuitry), first onboard charger circuitry 122, and second onboard charger circuitry 124. With reference to FIG. 1C (and also FIG. 1B), first electric motor circuitry 112 may provide a first set of electric power outputs to system 100, which may respectively correspond with a set of back electro motive force (BEMF) outputs of one or more electric motors. The first set of electric power outputs may also respectively correspond with a set of electric motor windings, each of which may be associated with a resistance R and an inductance L. In various embodiments, the first set of electric power outputs may provide an alternating-phase and/or multi-phase AC power source. For example, the first set of power outputs may together provide an alternating-phase, three-phase AC power source.

First onboard charger circuitry 122 may accept a set of electric power inputs from AC power source interface 192. For example, the electric power inputs may include three inputs carrying an alternating-phase, three-phase AC power source. (In some embodiments, the inputs may include a fourth input corresponding with the alternating-phase, three-phase AC power source, e.g., a neutral return input.)

First onboard charger circuitry 122 may provide the set of electric power inputs to an electro-magnetic interference (EMI) filter component, which may filter EMI out of the set of electric power inputs and may provide a set of filtered power inputs. In various embodiments, the EMI filter component may advantageously attenuate noise currents generated by switching circuitries of first onboard charger circuitry 122 (as discussed further herein), which may enhance efficient operation of the circuitry.

First onboard charger circuitry 122 may provide the filtered power inputs to a switch box component comprising a switch S22a, a switch S22b, a switch S22c, a switch S22d, a switch S22e, and a switch S22f. The switch box component may switch the set of filtered power inputs through these switches to provide a set of switched power inputs. In various embodiments, the switch box component may advantageously enable and/or facilitate the use of either single-phase or three-phase AC power (e.g., via the set of inputs from AC power source interface 192), depending upon power source parameters, such as the input utility voltage range, which may vary by region.

First onboard charger circuitry 122 may provide the set of switched power inputs to an inductor component, which may comprise a set of inductors corresponding with various power inputs of the switched power inputs (e.g., three inputs corresponding with a three-phase AC power source). The inductor component may process the set of switched power inputs in this manner and may thereby provide a set of inductor-processed power inputs. The inductors may advantageously reduce harmonic distortion and/or enhance efficient operation of the system, which may advantageously lead to reduced energy consumption and reduced wear-and-tear. (A neutral return input of the set of switched power inputs might not be processed by the inductors of the inductor component.)

Finally, in addition to receiving the first a set of electric power inputs from AC power source interface 192, first onboard charger circuitry 122 may also accept the first set of electric power outputs (from first electric motor circuitry 112). Both the inductor-processed power inputs and the first set of electric power inputs may be provided to a disconnect component, in which each electric power input of the first set of electric power inputs may be selectively connected to one of the inductor-processed power inputs, through one or more corresponding disconnect switches. As shown in FIG. 1C, a disconnect switch S22g and a disconnect switch S22h may each selectively disconnect one of the electric power inputs from a corresponding inductor-processed power inputs. In various embodiments, however, the disconnect component might not disconnect one of the electric power inputs from a corresponding inductor-processed power input. In this manner, when S22g and S22h are both open, two of the electric motor windings (e.g., that correspond with the electric power inputs of first electric motor circuitry 112) may be disconnected from the remainder of system 100 when system 100 is configured to charge a traction battery through traction battery interface 194. The disconnect component might accordingly provide a set of selectively-connected power inputs, which may then be provided as an electrical power output of first onboard charger circuitry 122 (which may thus present as an alternating-phase, three-phase AC power source and/or as a single-phase AC power source).

First onboard charger circuitry 122 may provide its output—which may include a set of three filtered, switched, inductor-processed, and selectively-connected electric power inputs from AC power source interface 192—to system 100. First onboard charger circuitry 122 may also provide a fourth output to system 100. In various embodiments, the first three outputs of first onboard charger circuitry 122 may comprise an L1 output, an L2 output, and an L3 output, and the fourth output of first onboard charger circuitry 122 may comprise a neutral wire (or N) output. Within system 100, the first three outputs may be provided to first component 114a, while the fourth output may be provided to second onboard charger circuitry 124.

First component 114a of the first ISC circuitry may accept the output of first onboard charger circuitry 122 and may provide it to a multi-phase bridge or rectifier circuitry. In various embodiments, the multi-phase bridge or rectifier circuitry may comprise a three-phase active bridge rectifier, in which a first electrical node (e.g., a lower-voltage electrical node, such as a ground node) is electrically connected through separate legs (which may be, e.g., switches and/or active components) to each of the three electrical power outputs of first onboard charger circuitry 122, and in which each of the three electrical power outputs of first onboard charger circuitry 122 are electrically connected through separate legs (which may be, e.g., switches and/or active components) to a second electrical node (e.g., a higher-voltage electrical node). A difference between the electrical characteristics of the first electrical node and the electrical characteristics of the second electrical node may represent at least a partial conversion of the AC power provided as input to First component 114a of the first ISC circuitry into a DC power output. First component 114a of the first ISC circuitry may output the first electrical node and the second electrical node to a first output and a second output, respectively, providing a first DC power to system 100.

Second component 114b of the first ISC circuitry may comprise a capacitor circuitry, which may include one or more capacitive elements (e.g., in serial and/or in parallel) between, and electrically connected to, the first output and the second output of first component 114a of the first ISC circuitry (and, thus, to the first electrical node and second electrical node of first component 114a). A capacitance C of second component 114b may serve to smooth out a voltage of the first DC power (e.g., on the outputs of first component 114a). First component 114a and second component 114b of the first ISC circuitry may thus cooperatively supply a smoothed first DC power to system 100.

Second onboard charger circuitry 124 may be electrically connected to the output of second component 114b of the first ISC circuitry (and may thus be electrically coupled to the smoothed first DC power provided by first component 114a and second component 114b). Second onboard charger circuitry 124 may have a first input and a second input that are electrically connected to the first output and the second output, respectively, of first component 114a (and, thus, to the first electrical node and second electrical node of first component 114a). The design of second onboard charger circuitry 124 may relate to three internal electrical nodes. The first input of second onboard charger circuitry 124 may be electrically connected through a first switching leg (which may include, e.g., switches and/or active components) to the first internal electrical node, and the first internal electrical node may then be electrically connected through a second switching leg (which may include, e.g., switches and/or active components) to the second input. In various embodiments, switches and/or active components of the first switching leg and/or the second switching leg may be and/or may include metal-oxide-semiconductor field-effect transistors (MOSFETs). The second internal electrical node may be electrically connected to the fourth output of first onboard charger circuitry 122 (which may provide, e.g., a neutral wire or N output). The third internal electrical node may be electrically connected through a first capacitor to the first input, and may also be electrically connected through a second capacitor to the second input. A switch S26a may connect the first internal electrical node to the second internal electrical node, and a switch S26b may connect the second internal electrical node to the third internal electrical node. Second onboard charger circuitry 124 may thereby further affect the electrical characteristics of the smoothed first DC power output (e.g., as discussed further herein).

Second onboard charger circuitry 124 may thus include various switching legs, energy storage capacitors (which may be made of, for example, an electrolytic capacitor), and disconnection switches. The first motor inverter system, first onboard charger circuitry 122, and second onboard charger circuitry 124 may advantageously enable a vehicle to charge a traction battery (e.g., a high-voltage battery) coupled to traction battery interface 194) from three-phase, two-phase, and/or single-phase power sources. Meanwhile, first onboard charger circuitry 122 and/or second onboard charger circuitry 124 may be operable to enhance an efficiency of system 100 and to enable and/or facilitate the charging of a traction battery from different power sources.

When the AC source is a single-phase source, MOSFETs in second onboard charger circuitry 124 (e.g., of the first switching leg and/or the second switching leg) may operate as a low frequency rectifier, for example by switching at the same frequency as the AC source, and a current may be carried via the neutral wire (e.g., the fourth output of second onboard charger circuitry 124) back to the AC source (e.g., via first onboard charger circuitry 122). Alternatively, when the AC source is a three-phase source, the switches in second onboard charger circuitry 124 (e.g., switch S26a and/or switch S26b) may configure the third internal electrical node of second onboard charger circuitry 124 (between the first capacitor and the second capacitor of second onboard charger circuitry 124) to connect to the neutral wire (e.g., the fourth output of second onboard charger circuitry 124), and a current may be carried via the neutral wire (e.g., the fourth output of second onboard charger circuitry 124) back to the AC source (e.g., via first onboard charger circuitry 122).

FIG. 1D shows another portion of the circuit topology of system 100, including the second motor inverter system (e.g., second electric motor circuitry 162, first component 164a of the second ISC circuitry, and second component 164b of the second ISC circuitry) and third onboard charger circuitry 176. Second electric motor circuitry 162, first component 164a, and second component 164b may be substantially similar to first electric motor circuitry 112, first component 114a, and second component 114b, as discussed herein. With reference to FIG. 1D (and also FIG. 1B), second electric motor circuitry 162 may provide a second set of electric power outputs to system 100. The second set of power outputs may be provided to first component 164a of the second ISC circuitry, which may in turn provide a second DC power to system 100; and first component 164a of the second ISC circuitry and second component 164b of the second ISC circuitry may cooperatively provide a smoothed second DC power to system 100 based thereon (in a manner similar to that discussed herein regarding the first DC power and the smoothed first DC power). In various embodiments, first component 164a may comprise a traction inverter and/or traction inverter switches.

The second set of power outputs may also be provided to third onboard charger circuitry 176. In a first component of third onboard charger circuitry 176, a switch S36a, a switch S36b, and a switch S36c correspond respectively with three electric power inputs (and, through them, through the three electric power outputs of the second set of electric power outputs). This first component may provide a switching component to third onboard charger circuitry 176. The switches may either transmit or block each of the electric power outputs from propagating from the electrical power inputs a second component of third onboard charger circuitry 176. In the second component, the three propagated electrical power inputs are provided to three parallel capacitor-inductor-inductor-capacitor (CLLC) resonant circuitries, having inductively coupled inductors. This second component may provide a transformer component to third onboard charger circuitry 176. The second component may then provide three coupled electrical power signals to a third component of third onboard charger circuitry 176, which may be substantially similar to multi-phase bridge or rectifier circuitry component of first component 114a of the first ISC circuitry, and may provide a third DC power to system 100. A fourth component of third onboard charger circuitry 176, which may be substantially similar to second component 114b of the first ISC circuitry, may comprise a capacitor circuitry that serves to smooth out a voltage of the third DC power, and the third component and fourth component may thus cooperatively supply a smoothed third DC power to system 100. This third component and/or this fourth component may provide a bridge component to third onboard charger circuitry 176.

The first (e.g., higher-voltage) electrical node of the smoothed first DC power (cooperatively supplied by first component 114a and second component 114b of the first ISC circuitry, and further electrically affected by second onboard charger circuitry 124) may be electrically connected to the first (e.g., higher-voltage) electrical node of the smoothed second DC power (cooperatively supplied by first component 164a and second component 164b of the second ISC circuitry). Similarly, the second (e.g., lower-voltage) electrical node of the smoothed first DC power may be electrically connected to the second (e.g., lower-voltage) electrical node of the smoothed second DC

Turning to FIG. 1E, first onboard charger circuitry 122, the first ISC circuitry (with first component 114a and second component 114b), and second onboard charger circuitry 124 may work together to configure an onboard power conversion system of system 100 as a bi-directional power factor correction (PFC) circuit. This circuitry may accept an AC input voltage from an AC power grid (e.g., through AC power source interface 192) and may output a DC output voltage (e.g., through the smoothed first DC power, as further processed by second onboard charger circuitry 124). That DC output voltage may include a low-frequency ripple voltage (e.g., at 120 hertz (Hz) if the AC power grid is supplied by a 60 Hz source voltage). During charging of a battery coupled to traction battery interface 194 from the AC power grid, switch S22g and switch S22h may be opened to disconnect two of the electric motor's windings from the inverter circuitry while keeping a third electric motor winding connected to the inverter circuitry.

Turning to FIG. 1F, the second motor inverter system (with second electric motor circuitry 162, and the second ISC circuitry with its first component 164a and second component 164b) and the second onboard charger circuitry may together form a bi-directional isolated DC-DC converter circuit. The second electric motor circuitry 162 and the second ISC circuitry may accordingly be referenced to one side of a transformer circuitry. During charging of a traction battery coupled to traction battery interface 194 from the AC power grid, switch S36a, switch S36b, and switch S36c of third onboard charger circuitry 176 may be closed, and the second ISC circuitry and second onboard charger circuitry 124 may be configured to form a three-phase CLLC DC-DC converter. In some alternative embodiments, a single-phase CLLC may be configured by merely connecting to two switching legs in the second ISC circuitry. For some embodiments, other topologies may also be implemented, such as a dual active bridge (DAB) topology or an inductor-inductor-capacitor (LLC) topology. Second onboard charger circuitry 124 may be directly interfaced with the second ISC circuitry without disconnecting an attached electric motor.

Turning to FIG. 1G, in addition to the bi-directional PFC circuit and the bi-directional isolated DC-DC converter circuit discussed herein, the second motor inverter system (with second electric motor circuitry 162, and the second ISC circuitry with its first component 164a and second component 164b) and third onboard charger circuitry 176 may form an isolated DC-DC converter circuit. A battery current control function may advantageously be activated by operating the configured bi-directional PFC circuit (of FIG. 1E) and the isolated DC-DC converter circuit together. An onboard power conversion system of system 100 may accept AC input from the AC power grid and may output an isolated DC voltage at the output of third onboard charger circuitry 176.

Third onboard charger circuitry 176 may accordingly comprise a switching component, a transformer component, and a bridge component. The various components of third onboard charger circuitry 176 may be operable to galvanically isolate an input AC voltage from a converted high-voltage DC voltage.

FIG. 1G accordingly shows portions of the circuit topology of system 100 forming an onboard charger having two power conversion stages. In a first stage, an AC-to-DC converter accepts AC input from an AC power grid and converts it to a DC output, which appears across the capacitor of second component 164b (of the second ISC circuitry). This DC voltage may be an input to the second stage, which may be an isolated DC-DC converter.

In various embodiments, traction inverter switches (e.g., of first component 164a), an electric machine (e.g., of second electric motor circuitry 162), and third onboard charger circuitry 176 may form an isolated DC-DC converter. With reference to FIGS. 1B and 1G, in various implementations, system 100 may include a three-phase resonant CLLC DC-DC converter, using the traction inverter switches and the electric machine. The traction inverter switches may form a primary bridge. A small current may be expected to flow through the electric machine (since it is connected to the inverter during the charging operation). Switch S36a, switch S36b, and switch S36c of third onboard charger circuitry 176, which may be connected in series with a transformer's primary winding, may be closed during charging and opened when a vehicle is in a drive mode. This may facilitate and/or enable the disconnection of third onboard charger circuitry 176 when the vehicle is disconnected from the AC power grid. This topology may advantageously not include a separate bridge circuitry before the transformer stage and may advantageously make use of the converter in the traction inverter switches.

With reference to FIGS. 1A and 1B, first battery disconnect circuit 134 may be opened during a charging operation, which may in turn result in an intermediate DC bus (e.g., the smoothed first DC power) and/or input to the configured isolated DC-DC converter circuit (e.g., of FIG. 1F) being isolated from a traction battery coupled to traction battery interface 194 (e.g., an HV traction battery). Meanwhile, during a charging operation, second battery disconnect circuit 184 may be closed, and may otherwise be open. Thus, second battery disconnect circuit 184 may advantageously isolate a traction battery coupled to traction battery interface 194 during charging, and may thereby mitigate potential issues and increase a reliability of a vehicle during a charging operation.

Various switches discussed herein (e.g., of first onboard charger circuitry 122, second onboard charger circuitry 124, and/or third onboard charger circuitry 176) and/or battery disconnect contactors (e.g., of first battery disconnect circuit 134 and/or second battery disconnect circuit 184) may be implemented using mechanical relays, mechanical contactors, and/or semiconductor switches, including bidirectional semiconductor switches which may block voltage with a positive or negative polarity, and/or which may pass current bi-directionally.

FIGS. 2A-2C depict a system 200 (and portions thereof) in which an AC-to-DC onboard charger has been integrated with a dual motor inverter, with an alternative design for some circuitries of the AC-to-DC onboard charger. FIG. 2A shows a schematic view of system 200, illustrating various circuitries that form the dual motor inverter system of system 200, as well as the AC-to-DC onboard charger of system 200. The dual motor inverter system of system 200 includes a first electric motor circuitry 212, a first component 214a of a first ISC circuitry, a second component 214b of the first ISC circuitry, a second electric motor circuitry 262, a first component 264a of a second ISC circuitry, and a second component 264b of the second ISC circuitry. The AC-to-DC onboard charger of system 200 includes a first onboard charger circuitry 222, a second onboard charger circuitry 224, and a third onboard charger circuitry 276. Except as discussed otherwise herein, the various systems, circuits, circuitries, and components of system 200 may be substantially similar to the correspondingly-named and/or similarly-numbered systems, circuits, circuitries, and components of system 100, and may interact with each other in substantially similar ways.

With reference to FIG. 1C (and also FIG. 1B), as with second onboard charger circuitry 124, second onboard charger circuitry 224 may have a first internal electrical node (between switching legs), a second internal electrical node (between relays), and a third internal electrical node (between capacitors). In addition, as with second onboard charger circuitry 124, second onboard charger circuitry 224 may have a switch S26a that may connect the second internal electrical node to the third internal electrical node. Also, the third electrical node may be electrically connected, through a respective first capacitor and a second capacitor, to the first input and second input of second onboard charger circuitry 124. Finally, the second internal electrical node may be electrically connected to a fourth output of first onboard charger circuitry 222.

However, in first component 214a of the first ISC circuitry, a first electrical node (e.g., a lower-voltage electrical node) is electrically connected through separate legs (e.g., switches) to merely two of the three electrical power outputs of first onboard charger circuitry 222, and merely two of the three electrical power outputs of first onboard charger circuitry 222 are electrically connected through separate legs (e.g., switches) to a second electrical node (e.g., a higher-voltage electrical node). A switch S26a may connect a fourth internal node of second onboard charger circuitry 224, through separate legs (e.g., switches) of first component 214a of the first ISC circuitry, to the lower-voltage electrical node and higher-voltage electrical nodes of first component 214a. Meanwhile, the third of the three electrical power outputs of first onboard charger circuitry 222 may be electrically connected to the first internal electrical node of second onboard charger circuitry 224 (e.g., between switching legs).

The first (e.g., higher-voltage) electrical node of the smoothed first DC power (cooperatively supplied by first component 214a and second component 214b of the first ISC circuitry, and further electrically affected by second onboard charger circuitry 224) may be electrically connected to the first (e.g., higher-voltage) electrical node of the smoothed second DC power (cooperatively supplied by first component 164a and second component 164b of the second ISC circuitry). Similarly, the second (e.g., lower-voltage) electrical node of the smoothed first DC power may be electrically connected to the second (e.g., lower-voltage) electrical node of the smoothed second DC power.

In the alternative design of system 200, second onboard charger circuitry 224 may advantageously be utilized to carry a grid phase current, while one inverter switching leg is utilized to carry a neutral current, when the system is connected to a single-phase AC ground.

The systems, circuits, circuitries, and components disclosed herein may advantageously enable a single design to perform both a charging function and a traction drive function while minimizing a number of relays and disconnect circuits used. In various embodiments, the systems, circuits, circuitries, and components may advantageously reduce and/or eliminate bridge and/or rectifier circuitry that might be used in designs in which onboard charger circuitries are not integrated with dual motor inverter systems.

FIG. 3 depicts a vehicle 300 having a vehicle propulsion system with an internal combustion engine 301. As described herein, FIG. 3 shows one cylinder of engine 301. However, engine 301 may have a plurality of cylinders similar to the cylinder shown, along with corresponding pluralities of pistons, intake valves, exhaust valves, fuel injectors, spark plugs, and so forth.

Engine 301 may be controlled at least partially by a control system including a controller 312 and by input from a vehicle operator 382 via various input devices. In this example, an input device 380 includes a foot pedal and a pedal position sensor 384 for sensing force applied (e.g., by a foot of operator 382) and generating a pedal position signal (e.g., proportional to the sensed force).

Engine 301 includes a combustion chamber 330 and a cylinder formed by cylinder walls 332. A piston 336 positioned therein may be coupled to a crankshaft 340 so that a reciprocating motion of the piston is translated into a rotational motion of the crankshaft. Crankshaft 340 may be coupled to at least one drive wheel of vehicle 300 via an intermediate transmission system. Further, a starter motor may be coupled to crankshaft 340 via a flywheel to enable a starting operation of engine 301.

Combustion chamber 330 may receive intake air from an intake manifold 344 via an intake passage 342 and may exhaust combustion gases via an exhaust manifold 348. Intake manifold 344 and exhaust manifold 348 can selectively communicate with combustion chamber 330 via an intake valve 352 and an exhaust valve 354, respectively. In some examples, combustion chamber 330 may include two or more intake valves and/or two or more exhaust valves.

A fuel injector 366 is coupled directly to combustion chamber 330 for injecting fuel directly therein (e.g., via direct injection). The fuel may be injected in proportion to a pulse width of a signal received from controller 312. The fuel injector may be mounted in the side of the combustion chamber or in the top of the combustion chamber, for example. Fuel may be delivered to fuel injector 366 by a fuel system which may include a fuel tank, a fuel pump, and/or a fuel rail. In some examples, a high pressure, dual stage fuel system may be used to generate higher fuel pressures. For some examples, combustion chamber 330 may alternatively or additionally include a fuel injector arranged in intake manifold 344 in a configuration that provides what is known as port injection of fuel into the intake port, upstream of combustion chamber 330.

A distributorless ignition system 388 provides an ignition spark to combustion chamber 330 via a spark plug 392 (e.g., in response to controller 312). The ignition system may further comprise an ignition coil (not shown) for increasing voltage supplied to spark plug 392. In other examples, such as examples based on diesel fuel, spark plug 392 may be omitted.

During operation, each cylinder within engine 301 typically undergoes a four stroke cycle having an intake stroke, a compression stroke, an expansion stroke, and an exhaust stroke. During the intake stroke, generally, the exhaust valve 354 closes and intake valve 352 opens. Air is introduced into combustion chamber 330 via intake manifold 344, and piston 336 moves to the bottom of the cylinder so as to increase the volume within combustion chamber 330. The position at which piston 336 is near the bottom of the cylinder and at the end of its stroke (e.g., when combustion chamber 330 is at its largest volume) is typically referred to by those of skill in the art as bottom dead center (BDC).

During the compression stroke, intake valve 352 and exhaust valve 354 are closed. Piston 336 moves toward the cylinder head so as to compress the air within combustion chamber 330. The point at which piston 336 is at the end of its stroke and closest to the cylinder head (e.g., when combustion chamber 330 is at its smallest volume) is typically referred to by those of skill in the art as top dead center (TDC). In a process referred to as injection, fuel is introduced into the combustion chamber. In a process referred to as ignition, the injected fuel is ignited by known ignition means (such as spark plug 392), resulting in combustion.

During the expansion stroke, the expanding gases push piston 336 back to BDC, and crankshaft 340 converts piston movement into a rotational torque of the rotary shaft. Finally, during the exhaust stroke, the exhaust valve 354 opens to release the combusted air-fuel mixture to exhaust manifold 348, and the piston returns to TDC.

Note that the above is shown merely as an example, and that intake and exhaust valve opening and/or closing timings may vary (such as to provide positive or negative valve overlap, late intake valve closing, or various other examples).

An exhaust gas sensor 326 is shown coupled to exhaust manifold 348 upstream of a catalytic converter 370 in a direction of exhaust flow. The exhaust gas sensor 326 may be any suitable sensor for providing an indication of exhaust gas air-fuel ratio, such as a linear oxygen sensor or UEGO (universal or wide-range exhaust gas oxygen) sensor, a two-state exhaust gas oxygen sensor or EGO sensor, a HEGO (heated EGO) sensor, a NOx sensor, an HC sensor, or a CO sensor. In one example, upstream exhaust gas sensor 326 is a UEGO configured to provide output, such as a voltage signal, that is proportional to the amount of oxygen present in the exhaust. Controller 312 may convert an oxygen sensor output into an exhaust gas air-fuel ratio via an oxygen sensor transfer function.

Converter 370 can include multiple catalyst bricks, in one example. In another example, multiple emission control devices, each with multiple bricks, can be used. Converter 370 can be a three-way type catalyst in one example.

Controller 312 is shown in FIG. 3 as a microcomputer, including a microprocessor unit 302, input/output ports 304, an electronic storage medium for storing executable programs and calibration values which is shown as a read-only memory chip 306 (e.g., non-transitory memory) in this particular example, a random access memory 308, and/or a keep alive memory 310, which may be interconnected by various control busses and/or data busses. Other controllers mentioned herein may have similar designs and configurations. The storage medium read-only memory chip 306 can be programmed with computer readable data representing non-transitory instructions executable by the microprocessor unit 302 for performing at least portions of the methods described herein, as well as other variants of the methods described herein that are anticipated but not specifically listed.

Controller 312 may receive signals from various sensors coupled to engine 301. Controller 312 may also receive input from an operator/machine interface (e.g., pushbutton or touch screen display). In addition to receiving signals from sensors previously discussed, controller 312 may receive signals including: an engine coolant temperature (ECT) from a temperature sensor 323 coupled to a cooling sleeve 314; a measurement of engine manifold pressure (MAP) from pressure sensor 322 coupled to intake manifold 344; an engine position signal from a crankshaft position sensor 318 (e.g., a Hall effect sensor, or another type of sensor) sensing a position of crankshaft 340; a measurement of air mass entering the engine from sensor 320; and/or a manifold pressure signal (which may provide an indication of vacuum, or pressure, in the intake manifold 344). Barometric pressure may also be sensed (sensor not shown) for processing by controller 312.

In one example, the crankshaft position sensor 318 may produce a predetermined number of equally spaced pulses every revolution of the crankshaft, from which engine speed (RPM) can be generated or determined (e.g., via controller 312). Accordingly, crankshaft position sensor 318 may also be used as an engine speed sensor. During engine operation, engine torque may be inferred from the output of MAP sensor 322 and engine speed. Further, this sensor, along with the detected engine speed, may be a basis for estimating charge (including air) inducted into the cylinder.

Vehicle 300 is depicted as having a spark ignition engine. However, in various examples, the vehicle propulsion system of vehicle 300 may include a diesel engine, a turbine, or an electric machine. In some examples, vehicle 300 may be a hybrid vehicle with multiple sources of torque available to one or more vehicle wheels 375. In other examples, vehicle 300 is a conventional vehicle with merely an engine, or an electric vehicle with merely electric machine(s).

In the example shown, vehicle 300 includes engine 301 and an electric machine 372. Electric machine 372 may be a motor or a motor/generator. Crankshaft 340 of engine 301 and electric machine 372 are connected via a transmission 374 to vehicle wheels 375 when one or more clutches 376 are engaged. In the depicted example, a first clutch 376 is provided between crankshaft 340 and electric machine 372, and a second clutch 376 is provided between electric machine 372 and transmission 374. Controller 312 may send a signal to an actuator of each clutch 376 to engage or disengage the clutch, so as to connect or disconnect crankshaft 340 from electric machine 372 and the components connected thereto, and/or connect or disconnect electric machine 372 from transmission 374 and the components connected thereto. Transmission 374 may be a gearbox, a planetary gear system, or another type of transmission. The powertrain may be configured in various manners including as a parallel, a series, or a series-parallel hybrid vehicle.

Electric machine 372 receives electrical power from a traction battery 378 to provide torque to vehicle wheels 375. Electric machine 372 may also be operated as a generator to provide electrical power to charge battery 378, for example during a wheel caliper operation. Accordingly, systems such as system 100 and/or system 200 disclosed herein may interface with electric machine 372 and/or traction battery 378 to provide torque to vehicle wheels 375, and to operate as a generator to provide electrical power to charge battery 378.

In this way, the circuit topologies disclosed herein may enable and/or facilitate the integration of AC-to-DC onboard chargers into dual motor inverter systems while reducing circuits, circuitries, and components used therein. This may in turn advantageously enable reduced system sizes, and/or weights, as disclosed herein, thus enhancing performance and/or enhancing driver experience. In various embodiments, a technical effect of the circuit topologies disclosed herein may be a reduction in the use of bridge and/or rectifier circuits and/or circuitries, and/or a sharing of bridge and/or rectifier circuits and/or circuitries between a dual motor inverter system and an AC-to-DC onboard charger.

The disclosure provides support for a dual motor inverter system, comprising: a first motor inverter system having a first electric motor circuitry and a first inverter system controller (ISC) circuitry, a second motor inverter system having a second electric motor circuitry and a second ISC circuitry, a first onboard charger circuitry electrically connected to the first electric motor circuitry and electrically connected to the first ISC circuitry, and a second onboard charger circuitry electrically connected to the first ISC circuitry, wherein the first onboard charger circuitry, the first ISC circuitry, and the second onboard charger circuitry form a bi-directional power factor correction circuit. In a first example of the system, the first onboard charger circuitry comprises an EMI filter portion, a switch box portion, an inductor portion, and a disconnection switch portion, and wherein the disconnection switch portion includes one or more disconnect switches operable to disconnect one or more corresponding windings of the first electric motor circuitry from the first ISC circuitry. In a second example of the system, optionally including the first example, the second electric motor circuitry, the second ISC circuitry, and the second onboard charger circuitry form a bi-directional isolated DC-DC converter circuit. In a third example of the system, optionally including one or both of the first and second examples, the second onboard charger circuitry comprises one or more energy storage capacitors, one or more switching legs, and a plurality of relays, and wherein the second onboard charger circuitry is operable to enable the dual motor inverter system to provide charge from a plurality of different power sources. In a fourth example of the system, optionally including one or more or each of the first through third examples, the system further comprises: a third onboard charger circuitry electrically connected to the second electric motor circuitry and the second ISC circuitry, wherein the second electric motor circuitry, the second ISC circuitry, and the third onboard charger circuitry form an isolated DC-DC converter circuit. In a fifth example of the system, optionally including one or more or each of the first through fourth examples, the third onboard charger circuitry comprises a switching component, a transformer component, and a bridge component, and wherein the third onboard charger circuitry is operable to galvanically isolate an input AC voltage from a converted high-voltage DC voltage. In a sixth example of the system, optionally including one or more or each of the first through fifth examples, the second onboard charger circuitry is operable to carry a grid phase current while one of the one or more switching legs is operable to carry a neutral current.

The disclosure also provides support for a dual motor inverter system, comprising: a first motor inverter system having a first electric motor circuitry and a first inverter system controller (ISC) circuitry, a second motor inverter system having a second electric motor circuitry and a second ISC circuitry, and an onboard charger circuitry electrically connected to the second ISC circuitry, wherein the second motor inverter system and the onboard charger circuitry form a bi-directional isolated DC-DC converter circuit. In a first example of the system, the onboard charger circuitry comprises one or more energy storage capacitors, one or more switching legs, and a plurality of relays, and wherein the onboard charger circuitry is operable to enable the dual motor inverter system to provide charge from a plurality of different power sources. In a second example of the system, optionally including the first example, the onboard charger circuitry is a second onboard charger circuitry, further comprising: a first onboard charger circuitry electrically connected to the first electric motor circuitry and electrically connected to the first ISC circuitry. In a third example of the system, optionally including one or both of the first and second examples, the first onboard charger circuitry, the first ISC circuitry, and the second onboard charger circuitry form a bi-directional power factor correction circuit. In a fourth example of the system, optionally including one or more or each of the first through third examples, the first onboard charger circuitry comprises an EMI filter portion, a switch box portion, an inductor portion, and a disconnection switch portion, and wherein the disconnection switch portion includes one or more disconnect switches operable to disconnect one or more corresponding windings of the first electric motor circuitry from the first ISC circuitry. In a fifth example of the system, optionally including one or more or each of the first through fourth examples, the system further comprises: a third onboard charger circuitry electrically connected to the second electric motor circuitry and the second ISC circuitry, wherein the second electric motor circuitry, the second ISC circuitry, and the third onboard charger circuitry form an isolated DC-DC converter circuit, wherein the third onboard charger circuitry comprises a switching component, a transformer component, and a bridge component, and wherein the third onboard charger circuitry is operable to galvanically isolate an input AC voltage from a converted high-voltage DC voltage. In a sixth example of the system, optionally including one or more or each of the first through fifth examples comprising: a traction battery interface, and a battery disconnect circuit operable to open and isolate the bi-directional isolated DC-DC converter circuit from the traction battery interface. In a seventh example of the system, optionally including one or more or each of the first through sixth examples, the onboard charger circuitry is operable to carry a grid phase current while one of the one or more switching legs is operable to carry a neutral current.

In an alternative fifth example of the system, optionally including one or more or each of the first through fourth examples, the system further comprises: a third onboard charger circuitry electrically connected to the second electric motor circuitry and the second ISC circuitry, wherein the second electric motor circuitry, the second ISC circuitry, and the third onboard charger circuitry form an isolated DC-DC. In an alternative sixth example of the system, optionally including one or more or each of the first through fifth examples, the third onboard charger circuitry comprises a switching component, a transformer component, and a bridge component, and wherein the third onboard charger circuitry is operable to galvanically isolate an input AC voltage from a converted high-voltage DC voltage.

The disclosure also provides support for a dual motor inverter system with an integrated AC-to-DC onboard charger, comprising: a first motor inverter system having a first electric motor circuitry and a first inverter system controller (ISC) circuitry, a second motor inverter system having a second electric motor circuitry and a second ISC circuitry, a first onboard charger circuitry electrically connected to the first electric motor circuitry and electrically connected to the first ISC circuitry, a second onboard charger circuitry electrically connected to the first ISC circuitry, and a third onboard charger circuitry electrically connected to the second electric motor circuitry. In a first example of the system, the first onboard charger circuitry, the first ISC circuitry, and the second onboard charger circuitry form a bi-directional power factor correction circuit, wherein the second electric motor circuitry, the second ISC circuitry, and the third onboard charger circuitry form a bi-directional isolated DC-DC converter circuit, and wherein the second electric motor circuitry, the second ISC circuitry, and the third onboard charger circuitry form an isolated DC-DC converter circuit. In a second example of the system, optionally including the first example, the first onboard charger circuitry comprises an EMI filter portion, a switch box portion, an inductor portion, and a disconnection switch portion, wherein the second onboard charger circuitry comprises one or more energy storage capacitors, one or more switching legs, and a plurality of relays, and wherein the third onboard charger circuitry comprises a switching component, a transformer component, and a bridge component. In a third example of the system, optionally including one or both of the first and second examples, the disconnection switch portion includes one or more disconnect switches operable to disconnect one or more corresponding windings of the first electric motor circuitry from the first ISC circuitry, wherein the second onboard charger circuitry is operable to enable the dual motor inverter system to provide charge from a plurality of different power sources, and wherein the third onboard charger circuitry is operable to galvanically isolate an input AC voltage from a converted high-voltage DC voltage. In a fourth example of the system, optionally including one or more or each of the first through third examples comprising: a traction battery interface, and a battery disconnect circuit operable to open and isolate the third onboard charger circuitry from the traction battery interface.

In an alternative second example of the system, optionally including the first example, the first onboard charger circuitry comprises an EMI filter portion, a switch box portion, an inductor portion, and a disconnection switch portion, and wherein the disconnection switch portion includes one or more disconnect switches operable to disconnect one or more corresponding windings of the first electric motor circuitry from the first ISC circuitry. In an alternative third example of the system, optionally including one or both of the first and second examples, the second onboard charger circuitry comprises one or more energy storage capacitors, one or more switching legs, and a plurality of relays, and wherein the second onboard charger circuitry is operable to enable the dual motor inverter system to provide charge from a plurality of different power sources. In an alternative fourth example of the system, optionally including one or more or each of the first through third examples, the third onboard charger circuitry comprises a switching component, a transformer component, and a bridge component, and wherein the third onboard charger circuitry is operable to galvanically isolate an input AC voltage from a converted high-voltage DC voltage.

Note that the example systems disclosed herein can be used with various engine and/or vehicle system configurations. For example, the above technology can be applied to V-6, I-4, I-6, V-12, opposed 4, and other engine types. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “connected” (as in the context of an electrical connection) signifies a direct contact between two elements. As used herein, the term “coupled” (as in the context of an electrical coupling) signifies either a direct contact or an indirect link between two elements. As used herein, terminology in which elements are presented in a list using “and/or” language means any combination of the listed elements. For example, “A, B, and/or C” may mean any of the following: A alone; B alone; C alone; A and B; A and C; B and C; or A, B, and C. As used herein, the terms “substantially the same as” or “substantially similar to” are construed to mean the same as with a tolerance for variation that a person of ordinary skill in the art would recognize as being reasonable. As used herein, an element or step recited in the singular and proceeded with the word “a” or “an” should be understood as not excluding plural of said elements or steps, unless such exclusion is stated. As used herein, references to “one embodiment” or “one example” of the present disclosure are not intended to be interpreted as excluding the existence of additional embodiments that also incorporate the recited features. As used herein, terms such as “first,” “second,” “third,” and so on are used merely as labels, and are not intended to impose any numerical requirements, any particular positional order, or any sort of implied significance on their objects. As used herein, terminology in which “an embodiment,” “some embodiments,” or “various embodiments” are referenced signify that the associated features, structures, or characteristics being described are in at least some embodiments, but are not necessarily in all embodiments. Moreover, the various appearances of such terminology do not necessarily all refer to the same embodiments. As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A dual motor inverter system, comprising:
a first motor inverter system having a first electric motor circuitry and a first inverter system controller (ISC) circuitry;
a second motor inverter system having a second electric motor circuitry and a second ISC circuitry;
a first onboard charger circuitry electrically connected to the first electric motor circuitry and electrically connected to the first ISC circuitry; and
a second onboard charger circuitry electrically connected to the first ISC circuitry,
wherein the first onboard charger circuitry, the first ISC circuitry, and the second onboard charger circuitry form a bi-directional power factor correction circuit.

2. The dual motor inverter system of claim 1,
wherein the first onboard charger circuitry comprises an EMI filter portion, a switch box portion, an inductor portion, and a disconnection switch portion; and
wherein the disconnection switch portion includes one or more disconnect switches operable to disconnect one or more corresponding windings of the first electric motor circuitry from the first ISC circuitry.

3. The dual motor inverter system of claim 1,
wherein the second electric motor circuitry, the second ISC circuitry, and the second onboard charger circuitry form a bi-directional isolated DC-DC converter circuit.

4. The dual motor inverter system of claim 1,
wherein the second onboard charger circuitry comprises one or more energy storage capacitors, one or more switching legs, and a plurality of relays; and
wherein the second onboard charger circuitry is operable to enable the dual motor inverter system to provide charge from a plurality of different power sources.

5. The dual motor inverter system of claim 1, further comprising:
a third onboard charger circuitry electrically connected to the second electric motor circuitry and the second ISC circuitry,
wherein the second electric motor circuitry, the second ISC circuitry, and the third onboard charger circuitry form an isolated DC-DC converter circuit.

6. The dual motor inverter system of claim 5,
wherein the third onboard charger circuitry comprises a switching component, a transformer component, and a bridge component; and
wherein the third onboard charger circuitry is operable to galvanically isolate an input AC voltage from a converted high-voltage DC voltage.

7. The dual motor inverter system of claim 4,
wherein the second onboard charger circuitry is operable to carry a grid phase current while one of the one or more switching legs is operable to carry a neutral current.

8. A dual motor inverter system, comprising:
a first motor inverter system having a first electric motor circuitry and a first inverter system controller (ISC) circuitry;
a second motor inverter system having a second electric motor circuitry and a second ISC circuitry; and
an onboard charger circuitry electrically connected to the second ISC circuitry,
wherein the second motor inverter system and the onboard charger circuitry form a bi-directional isolated DC-DC converter circuit.

9. The dual motor inverter system of claim 8,
wherein the onboard charger circuitry comprises one or more energy storage capacitors, one or more switching legs, and a plurality of relays; and
wherein the onboard charger circuitry is operable to enable the dual motor inverter system to provide charge from a plurality of different power sources.

10. The dual motor inverter system of claim 8, wherein the onboard charger circuitry is a second onboard charger circuitry, further comprising:
a first onboard charger circuitry electrically connected to the first electric motor circuitry and electrically connected to the first ISC circuitry.

11. The dual motor inverter system of claim 10,
wherein the first onboard charger circuitry, the first ISC circuitry, and the second onboard charger circuitry form a bi-directional power factor correction circuit.

12. The dual motor inverter system of claim 10,
wherein the first onboard charger circuitry comprises an EMI filter portion, a switch box portion, an inductor portion, and a disconnection switch portion; and
wherein the disconnection switch portion includes one or more disconnect switches operable to disconnect one or more corresponding windings of the first electric motor circuitry from the first ISC circuitry.

13. The dual motor inverter system of claim 10, further comprising:
a third onboard charger circuitry electrically connected to the second electric motor circuitry and the second ISC circuitry,
wherein the second electric motor circuitry, the second ISC circuitry, and the third onboard charger circuitry form an isolated DC-DC converter circuit;
wherein the third onboard charger circuitry comprises a switching component, a transformer component, and a bridge component; and
wherein the third onboard charger circuitry is operable to galvanically isolate an input AC voltage from a converted high-voltage DC voltage.

14. The dual motor inverter system of claim 13, comprising:
a traction battery interface; and
a battery disconnect circuit operable to open and isolate the bi-directional isolated DC-DC converter circuit from the traction battery interface.

15. The dual motor inverter system of claim 9,
wherein the onboard charger circuitry is operable to carry a grid phase current while one of the one or more switching legs is operable to carry a neutral current.

16. A dual motor inverter system with an integrated AC-to-DC onboard charger, comprising:
a first motor inverter system having a first electric motor circuitry and a first inverter system controller (ISC) circuitry;
a second motor inverter system having a second electric motor circuitry and a second ISC circuitry;
a first onboard charger circuitry electrically connected to the first electric motor circuitry and electrically connected to the first ISC circuitry;
a second onboard charger circuitry electrically connected to the first ISC circuitry; and
a third onboard charger circuitry electrically connected to the second electric motor circuitry.

17. The dual motor inverter system with an integrated AC-to-DC onboard charger of claim 16,
wherein the first onboard charger circuitry, the first ISC circuitry, and the second onboard charger circuitry form a bi-directional power factor correction circuit;
wherein the second electric motor circuitry, the second ISC circuitry, and the third onboard charger circuitry form a bi-directional isolated DC-DC converter circuit; and
wherein the second electric motor circuitry, the second ISC circuitry, and the third onboard charger circuitry form an isolated DC-DC converter circuit.

18. The dual motor inverter system with an integrated AC-to-DC onboard charger of claim 17,
wherein the first onboard charger circuitry comprises an EMI filter portion, a switch box portion, an inductor portion, and a disconnection switch portion;
wherein the second onboard charger circuitry comprises one or more energy storage capacitors, one or more switching legs, and a plurality of relays; and
wherein the third onboard charger circuitry comprises a switching component, a transformer component, and a bridge component.

19. The dual motor inverter system with an integrated AC-to-DC onboard charger of claim 18,
wherein the disconnection switch portion includes one or more disconnect switches operable to disconnect one or more corresponding windings of the first electric motor circuitry from the first ISC circuitry;
wherein the second onboard charger circuitry is operable to enable the dual motor inverter system to provide charge from a plurality of different power sources; and
wherein the third onboard charger circuitry is operable to galvanically isolate an input AC voltage from a converted high-voltage DC voltage.

20. The dual motor inverter system with an integrated AC-to-DC onboard charger of claim 16, comprising:
a traction battery interface; and
a battery disconnect circuit operable to open and isolate the third onboard charger circuitry from the traction battery interface.
